(19) United States
(12) Patent Application Publication
(10) Pub. No.: US 2010/0151949 A1
(43) Pub. Date: Jun. 17, 2010

(54) ELECTRICAL ISOLATION OF A DRIVELINE SYSTEM VIA A NON-CONDUCTIVE INTERFACE ON A DRIVESHAFT ASSEMBLY

(75) Inventors: Steven W. Creek, Shelby Township, MI (US); James M. Dimond, Grosse Pointe Farms, MI (US); John Overholt, Windsor (CA); Kevin M. Ledford, Macomb, MI (US); Michael A. Voight, Troy, MI (US)

Correspondence Address: Quinn Law Group, PLLC, 39555 Orchard Hill Place, Suite 520, Novi, MI, 48375, US

(73) Assignees: GM GLOBAL TECHNOLOGY OPERATIONS, INC., Detroit, MI (US); AMERICAN AXLE & MANUFACTURING, INC., Detroit, MI (US)

(21) Appl. No.: 12/333,606

(22) Filed: Dec. 12, 2008

(51) Int. Cl. F16D 3/70; F16D 7/00

(52) U.S. Cl. 464/70; 464/87

(57) ABSTRACT

A vehicle driveline with a transmission having at least one motor/generator and an output shaft is provided. A driveshaft assembly is rotatably connected to the output shaft. The driveshaft assembly includes an isolator located between the transmission and at least a portion of the driveshaft assembly to electrically isolate the driveshaft assembly from the transmission.

### TECHNICAL FIELD

The present invention relates generally to a hybrid vehicle, and more specifically to an arrangement to reduce the transmission of noise within a vehicle driveline.

### BACKGROUND OF THE INVENTION

Vehicle drivelines transmit power from a vehicle engine through a transmission and then to the front wheels, rear wheels or all four wheels as desired. Commonly, a driveshaft assembly, or propshaft, is used to transmit torque from an output shaft of the transmission to the rear of the vehicle. The driveshaft assembly would then be connected to an axle, to propagate the torque to the vehicle wheels.

Driveshaft assemblies are known to transmit noise and vibration from operation of the engine, transmission, and the driveshaft assembly itself to the axle and from there into the passenger compartment of the vehicle. Dampers are commonly used within the driveline to reduce the vibration and noise from transmitting farther within the vehicle.

However, hybrid vehicles additionally produce electromagnetic frequencies (EMF) due to the electrical components in the hybrid system. The EMF can cause disruption of the various non-hybrid electrical systems in a vehicle. One impact of the EMF is degradation of the AM radio reception. However, traditional dampers do not prevent transmission of the electrical frequencies. In fact, driveshaft assemblies within the driveline system can amplify the EMF that are transferred to the driveline by the hybrid system.

### SUMMARY OF THE INVENTION

A vehicle having a driveline and a hybrid transmission where the transmission is electrically isolated from the remainder of the vehicle driveline is desired.

A vehicle driveline with a transmission having at least one motor/generator and an output shaft is provided. A driveshaft assembly is rotatably connected to the output shaft. The driveshaft assembly includes an isolator located between the transmission and at least a portion of the driveshaft assembly to electrically isolate the driveshaft assembly from the transmission.

The driveshaft assembly includes a transmission universal joint for mounting to a transmission, an axle universal joint for mounting to an axle and a shaft extending between the transmission universal joint and the axle universal joint. The isolator is located on the transmission universal joint.

A method for reducing noise and vibration in a vehicle driveline includes positioning the isolator on the driveshaft assembly to electrically isolate at least a portion of the driveshaft assembly from the transmission

The above features and advantages, and other features and advantages of the present invention will be readily apparent from the following detailed description of the preferred embodiments and best modes for carrying out the present invention when taken in connection with the accompanying drawings.

### BRIEF DESCRIPTION OF THE DRAWINGS

FIG. 1 is a schematic illustration of a vehicle having a driveline that includes a hybrid transmission;

FIG. 2 is a schematic perspective illustration of a driveshaft assembly for the driveline of FIG. 1;

FIG. 3 is a partial schematic perspective view of a yoke for the driveshaft assembly of FIGS. 1 and 2; and

FIG. 4 is an exploded perspective view of a portion of a universal joint for the driveshaft assembly of FIGS. 1 and 2.

### DESCRIPTION OF THE PREFERRED EMBODIMENTS

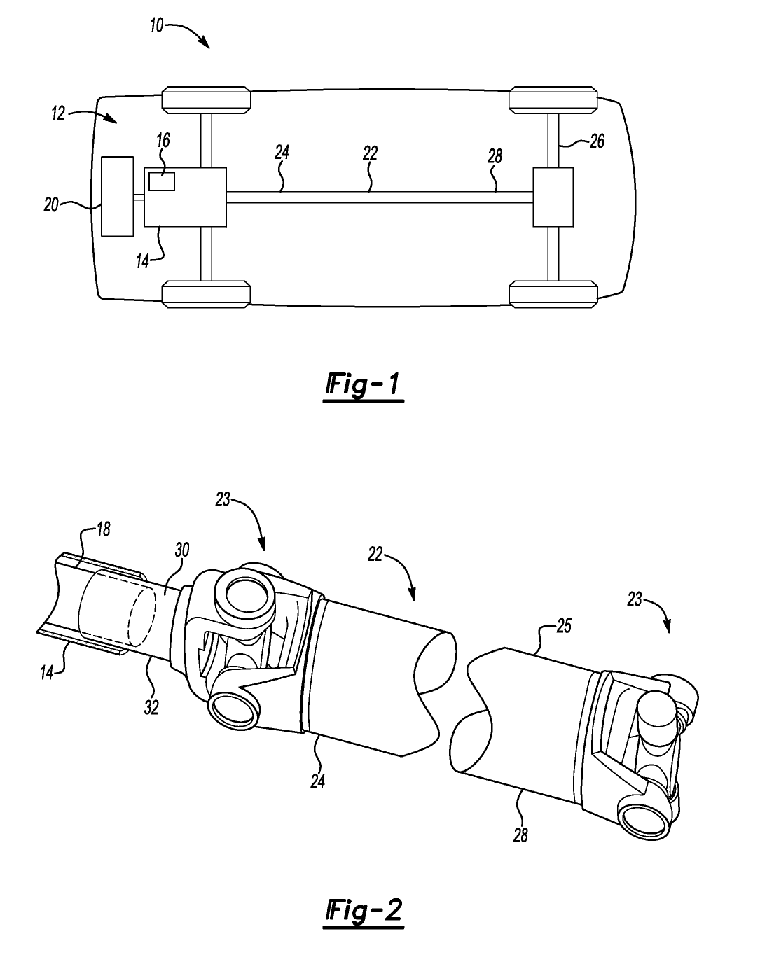

Referring to the Figures, wherein like reference numbers refer to the same or similar components throughout the several views, FIG. 1 is a schematic view of an exemplary vehicle 10, having a vehicle driveline 12 and an engine 20.

The vehicle driveline 12 includes a hybrid transmission 14. The hybrid transmission 14 has at least one motor/generator 16 located therein to assist the vehicle engine 20 and store power as is known for hybrid transmissions. The transmission 14 includes a transmission output shaft 18 (shown in FIG. 2) extending from the transmission 14. A driveshaft assembly 22 is mounted to the output shaft 18 at a first end portion 24 and to an axle 26 at a second end portion 28.

Referring to FIGS. 1 and 2, the driveshaft assembly 22 includes universal joints, or u-joints, 23 to allow for movement of the axle 26 in the vertical direction relative to the transmission 14. A shaft 25 extends from the first end portion 24 to the second end portion 28 of the driveshaft assembly 22 to connect the universal joints 23. The transmission output shaft 18 is preferably a male shaft. The driveshaft assembly 22 includes a female yoke 30 for mounting on the male transmission output shaft 18.

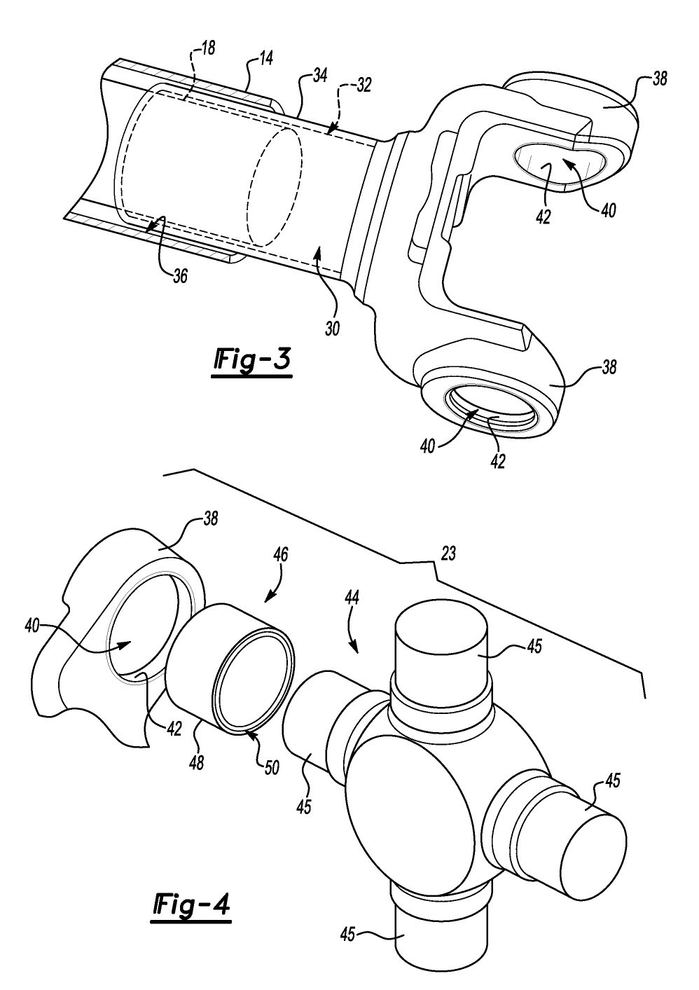

FIG. 3 illustrates the yoke 30 and a portion of the universal joint 23 for the driveshaft assembly. The yoke 30 includes a journal surface 32. A yoke isolator 34 is located on and surrounds the journal surface 32 to electrically isolate the journal surface 32 from the hybrid transmission 14. The yoke isolator 34 is preferably a ceramic or nylon sleeve. Other materials which act as electrical isolators may also be used. Alternatively, the yoke isolator 34 may be a coating of ceramic or nylon applied on the journal surface 32. The yoke isolator 34 electrically isolates the yoke 30 from the transmission 14. Specifically, the yoke isolator 34 is located between the journal surface 32 and a transmission surface 36. The yoke isolator 34 prevents electrical vibrations from the electric components, such as the motor/generator 16, within the transmission 14 from transmitting to the driveshaft assembly 22.

Referring to FIGS. 3 and 4, the universal joint 23 includes the yoke 30 which has yoke arms 38. Each of the yoke arms 38 defines a bore 40. FIG. 4 shows an exploded view of one of the yoke arms 38 for the universal joint 23. The other yoke arm 38 has a similar arrangement as described herein. A spider 44 for the universal joint 23 has a plurality of trunnions 45. One trunnion 45 is inserted within the bore 40. A bearing cup 46 is assembled on the spider 44 prior to assembly of the spider 44 within the bore 40. Thus, the bearing cup 46 is located between the spider 44 and the yoke arm 38.

The yoke arm 38 may have a bore isolator 42. The bore isolator 42 is preferably a ceramic or nylon coating applied to the yoke arm 38 within the bore 40 to electrically isolate the yoke arm 38 from the spider 44 for the universal joint 23.

A bearing isolator 48 may also be located on an outer surface 50 of the bearing cup 46 to electrically isolate the yoke arm 38 from the spider 44. The bearing isolator 48 is preferably a ceramic or nylon coating applied to the outer surface of the bearing cup 46 to electrically isolate the yoke arm 38 from the spider 44 for the universal joint 23.

By providing at least one of the yoke isolator 34, the bore isolator 42 and the bearing isolator 48, the transmission 14 is electrically isolated from the driveshaft assembly 22 and the remaining portion of the driveline 12. In particular, the shaft 25 of the driveshaft assembly 22 is electrically isolated from the transmission 14 to prevent amplification of any electrical vibrations associated with the various electric components, such as the motor/generator 16, within the transmission 14. The vehicle 10 may utilize one or any combination of the yoke isolator 34, bore isolator 42 and the bearing isolator 48 as is necessary to electrically isolate the transmission 14 from the remaining portion of the driveshaft assembly 22 and the driveline 12.

The above example describes a rear wheel-drive hybrid transmission 14 configuration. Other hybrid transmission configurations, such as front wheel-drive or all wheel-drive may benefit as well.

While the best modes for carrying out the invention have been described in detail, those familiar with the art to which this invention relates will recognize various alternative designs and embodiments for practicing the invention within the scope of the appended claims.

1. A vehicle driveline comprising:
a transmission having at least one motor/generator and an output shaft;
a driveshaft assembly rotatably connected to the output shaft; and
at least one isolator located between the transmission and at least a portion of the driveshaft assembly to electrically isolate the driveshaft assembly from the transmission.

2. The vehicle driveline of claim 1, wherein the driveshaft assembly further comprises:
a universal joint having a yoke which is mounted on the output shaft, wherein the universal joint includes:
a yoke arm defining a bore;
a spider located within the bore; and
a bearing cup located between the spider and the bore;
wherein the at least one isolator is one of a yoke isolator, a bore isolator and a bearing isolator.

3. The vehicle driveline of claim 2, wherein the yoke includes a journal surface and the yoke isolator is a non-conductive sleeve surrounding the journal surface such that the yoke isolator is located between the yoke and the transmission.

4. The vehicle driveline of claim 2, wherein the bore isolator is a non-conductive coating applied to the yoke arm within the bore such that the bore isolator is located between the yoke arm and the bearing cup.

5. The vehicle driveline of claim 2, wherein the bearing isolator is a non-conductive coating applied to an outer surface of the bearing cup such that the bearing isolator is located between the yoke arm and the bearing cup.

6. The vehicle driveline of claim 1, wherein the at least one isolator comprises one of a ceramic and a nylon material.

7. A driveshaft assembly comprising:
a transmission universal joint for mounting to a transmission wherein the transmission universal joint further includes:
a yoke having a yoke arm defining a bore;
a spider located within the bore; and
a bearing cup located between the spider and the bore;
an axle universal joint for mounting to an axle;
a shaft extending between the transmission universal joint and the axle universal joint;
at least one isolator located on the transmission universal joint for electrically isolating the driveshaft assembly from the transmission, wherein the at least one isolator is a yoke isolator.

8. The driveshaft assembly of claim 7, wherein the yoke includes a journal surface and the yoke isolator is a non-conductive sleeve surrounding the journal surface for locating the yoke isolator between the yoke and the transmission.

9. The driveshaft assembly of claim 7, wherein the at least one isolator further comprises one of a bore isolator and a bearing isolator.

10. The driveshaft assembly of claim 9, wherein the bore isolator is a non-conductive coating applied to the yoke arm within the bore such that the bore isolator is located between the yoke arm and the bearing cup.

11. The driveshaft assembly of claim 9, wherein the bearing isolator is a non-conductive coating applied to an outer surface of the bearing cup such that the bearing isolator is located between the yoke arm and the bearing cup.

12. The driveshaft assembly of claim 7, wherein the at least one isolator comprises one of a ceramic and a nylon material.

13. A method for reducing noise and vibration in a vehicle driveline of a transmission having at least one motor/generator and an output shaft, comprising:
positioning at least one isolator on a driveshaft assembly; and
mounting the driveshaft assembly on the output shaft of the transmission to electrically isolate at least a portion of the driveshaft assembly from the transmission.

14. The method of claim 13, wherein the positioning the at least one isolator on the driveshaft assembly further comprises, positioning a non-conductive sleeve on a yoke for the driveshaft assembly such that the non-conductive sleeve is located between the yoke and the transmission.

15. The method of claim 13, wherein the positioning the at least one isolator on the driveshaft assembly further comprises, applying a non-conductive coating on a yoke arm for the driveshaft assembly such that the non-conductive coating is located between a bearing cup for the driveshaft assembly and the yoke arm.

16. The method of claim 13, wherein the positioning the at least one isolator on the driveshaft assembly further comprises, applying a non-conductive coating on a bearing cup for the driveshaft assembly such that the non-conductive coating is located between a yoke arm for the driveshaft assembly and the bearing cup.
